(19) United States
(12) Patent Application Publication
(10) Pub. No.: US 2012/0086621 A1
(43) Pub. Date: Apr. 12, 2012

(54) ANTENNA DEVICE FOR PORTABLE TERMINAL

(75) Inventor: Jung-Hwan YEOM, Suwon-si (KR)

(73) Assignee: SAMSUNG ELECTRONICS CO. LTD., Suwon-si (KR)

(21) Appl. No.: 13/222,203

(22) Filed: Aug. 31, 2011

(30) Foreign Application Priority Data
Oct. 7, 2010 (KR) 10-2010-0097646

(51) Int. Cl. H01Q 1/48

(52) U.S. Cl. 343/845

(57) ABSTRACT

An antenna device of a portable terminal is provided. The device includes a main board, a bar antenna, and a connector. The main board includes a feeding portion for feeding electricity and a grounding portion for grounding. The bar antenna is movable while being electrically connected to the feeding portion so as to protrude to an outside of the portable terminal or to be inserted into the inside of the portable terminal. The connector electrically connects the grounding portion of the main board to the bar antenna only when the bar antenna is completely inserted into the portable terminal.

### PRIORITY

This application claims the benefit under 35 U.S.C. §119(a) of a Korean patent application filed in the Korean Intellectual Property Office on Oct. 7, 2010 and assigned Serial No. 10-2010-0097646, the entire disclosure of which is hereby incorporated by reference.

### BACKGROUND OF THE INVENTION

1. Field of the Invention

The present invention relates to an antenna device of a portable terminal. More particularly, the present invention relates to an antenna device of a portable terminal, for improving a radiation performance of an external monopole antenna whose radiation performance deteriorates when inserted or retracted into an inside of the portable terminal from an outside of the portable terminal.

2. Description of the Related Art

Currently, as the electronic communication industry develops, portable terminals such as a portable communication terminal (e.g., a cellular phone), an electronic scheduler, a personal digital assistant, or other similar portable and mobile electronic devices have become pervasive in modern society and provide an important means for quickly transferring information. Under these circumstances, portable terminals have been continuously developed to provide additional functions and to have a lightweight slim profile.

As the portable terminal provides the additional functions, it becomes difficult to mount the elements for multiple functions while maintaining a lightweight and a slim profile. For example, an antenna for radio wave transmission and reception has excellent performance when an antenna space for mounting the antenna is large. However, the antenna space for mounting the antenna becomes more and more narrow and/or small due to the increased amount of elements for the multiple functions.

Generally, a portable terminal uses a monopole antenna in order to transmit and receive a signal in a Digital Multimedia Broadcasting (DMB) frequency band. The monopole antenna is used by protruding to the outside of the portable terminal in order to transmit and receive radio waves in a relevant frequency band. While not in use, the monopole antenna may be hidden or retracted by being inserted into the portable terminal. The monopole antenna may transmit and receive radio waves even while inserted in the portable terminal, however, a radiation performance thereof deteriorates due to interference from other elements inside the portable terminal in comparison to radiation performance when the antenna is protruding outside of the portable terminal. FIG. 1 is a view illustrating a radiation characteristic of an external monopole antenna device of the related art. Referring to FIG. 1, when the monopole antenna is inserted into the portable terminal, the radiation performance deteriorates.

### SUMMARY OF THE INVENTION

Aspects of the present invention are to address at least the above-mentioned problems and/or disadvantages and to provide at least the advantages described below. Accordingly, an aspect of the present invention is to provide an antenna device of a portable terminal, for preventing a radiation performance from deteriorating when an external monopole antenna is inserted into the inside of the portable terminal from the outside of the portable terminal.

Another aspect of the present invention is to provide an antenna device of a portable terminal that operates as an external monopole antenna when a bar antenna protrudes to the outside of the portable terminal and that operates as a Planar Inverted F Antenna (PIFA) antenna when the bar antenna is inserted into the inside of the portable terminal.

In accordance with an aspect of the present invention, an antenna device of a portable terminal is provided. The antenna device includes a main board comprising a feeding portion for feeding electricity and a grounding portion for grounding, a bar antenna that is movable while being electrically connected to the feeding portion so as to protrude to an outside of the portable terminal or to be inserted into an inside of the portable terminal, and a connector for electrically connecting the grounding portion of the main board to the bar antenna when the bar antenna is completely inserted into the portable terminal.

In accordance with another aspect of the present invention, an antenna device of a portable terminal is provided. The antenna device has a main board including a feeding portion for feeding electricity and a grounding portion for grounding. The antenna device includes a bar antenna electrically connected to the feeding portion and movable so as to protrude to an outside position the portable terminal or retract to an inside position of the portable terminal; and a connector for electrically connecting the grounding portion of the main board to the bar antenna when the bar antenna is retracted into the portable terminal.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIG. 1 is a view illustrating a radiation characteristic of an external monopole antenna device of the related art;

FIG. 2 is a perspective view illustrating a portable terminal according to an exemplary embodiment of the present invention;

FIG. 3 is a schematic view illustrating an antenna device of a portable terminal according to an exemplary embodiment of the present invention;

FIG. 4 is a view illustrating an operation of an antenna device of a portable terminal according to an exemplary embodiment of the present invention; and

FIG. 5 is a view illustrating a radiation characteristic when an antenna device of a portable terminal operates as a Planar Inverted F Antenna (PIFA) antenna according to an exemplary embodiment of the present invention.

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions may be omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention is provided for illustration purpose only and not for the purpose of limiting the invention as defined by the appended claims and their equivalents.

It is to be understood that the singular forms “a”, “an”, and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

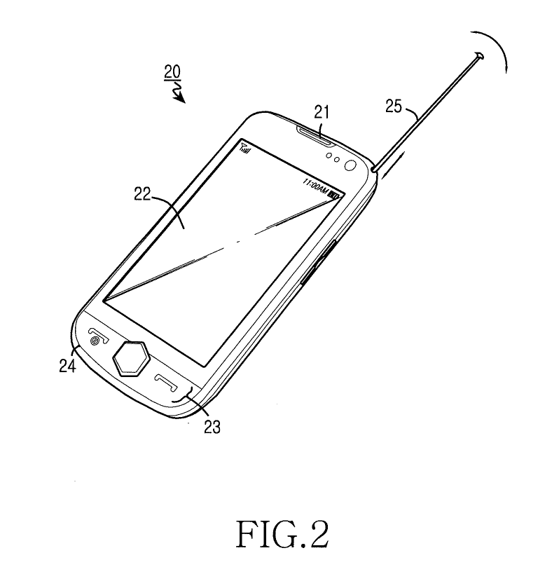

FIGS. 2 through 5, discussed below, and the various exemplary embodiments used to describe the principles of the present disclosure in this patent document are by way of illustration only and should not be construed in any way that would limit the scope of the disclosure. Those skilled in the art will understand that the principles of the present disclosure may be implemented in any suitably arranged communications system. The terms used to describe various embodiments are exemplary. It should be understood that these are provided to merely aid the understanding of the description, and that their use and definitions in no way limit the scope of the invention. Terms first, second, and the like are used to differentiate between objects having the same terminology and are in no way intended to represent a chronological order, unless where explicitly stated otherwise. A set is defined as a non-empty set including at least one element.

Exemplary embodiments of the present invention provide an antenna device. More particularly, exemplary embodiments of the present invention provide an antenna device of a portable terminal, for improving a radiation performance of an external monopole antenna that relatively deteriorates when inserted or retracted into an inside of the portable terminal from an outside of the portable terminal.

An antenna device of a portable terminal according to an exemplary embodiment of the present invention operates as a monopole antenna when a bar antenna protrudes to the outside of the portable terminal and operates as a Planar Inverted F Antenna (PIFA) antenna when the bar antenna is inserted into the inside of the portable terminal.

FIG. 2 is a perspective view illustrating a portable terminal according to an exemplary embodiment of the present invention.

Referring to FIG. 2, the portable terminal 20 includes a speaker 21 for outputting a voice signal, and a display 22 for outputting a video signal, wherein the display 22 is positioned below the speaker 21. Furthermore, the portable terminal 20 includes a keypad assembly 23 that serves as a data input unit, and a microphone 24 for receiving a voice signal, the microphone 24 being positioned below the keypad assembly 23. The display 22 may be a Liquid Crystal Display (LCD) having millions of pixels. In addition, in the case where a touch screen is provided to the LCD, the display 22 may perform the function of the data input unit as an auxiliary unit or in substitution for the keypad assembly 23. However, the present invention is not limited thereto, and the display 22 may be a Light Emitting Diode (LED) display, an Organic LED (OLED) display, or any of a variety of suitable displays.

More particularly, the portable terminal 20 includes an antenna device for transmitting and receiving radio waves. The antenna device according to an exemplary embodiment of the present invention includes a bar antenna 25 for the transmitting and receiving of the radio waves.

The antenna device, according to an exemplary embodiment of the present invention, operates as an external monopole antenna when the bar antenna 25 is extended so as to be outside of the portable terminal 20. Additionally, the bar antenna 25 operates as a PIFA antenna when the bar antenna 25 is inserted in the portable terminal. That is, the antenna device including the bar antenna 25 changes from the monopole antenna to the PIFA antenna according to a position of the bar antenna 25 being inside or outside of the portable terminal 20. Therefore, since the antenna device operates as the PIFA antenna when the bar antenna 25 is inserted into the portable terminal, a radiation performance of the bar antenna 24 serving as a radio wave radiator may be secured. Additionally, the bar antenna 25 that is protruded to the outside of the portable terminal may rotate.

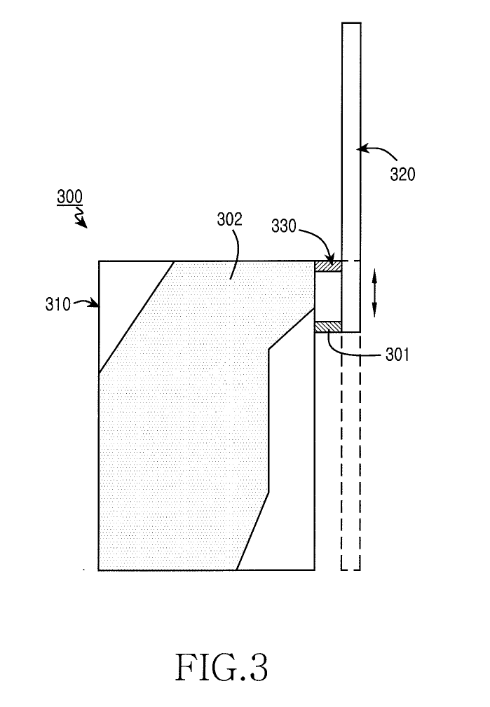

FIG. 3 is a schematic view illustrating an antenna device of a portable terminal according to an exemplary embodiment of the present invention.

Referring to FIG. 3, an antenna device 300 includes a main board 310 including a feeding portion 301 for feeding electricity and a grounding portion 302 for grounding, and a bar antenna 320 moving while electrically connected with the feeding portion 301 so as to be able to protrude to the outside of the portable terminal or to be inserted into the portable terminal. When fed from the feeding portion 301, the bar antenna 320 may transmit and receive radio waves. In addition, the antenna device 300 further includes a connector 330 for electrically connecting the grounding portion 302 of the main board 310 with the bar antenna 320 when the bar antenna 320 is completely inserted into the portable terminal.

As described above, the antenna device 300 may have the bar antenna 320 protrude to the outside of the portable terminal so as to operate as an external monopole antenna. In addition, the antenna device 300 may have the bar antenna 320 inserted into the inside of the portable terminal to operate as a PIFA antenna.

The main board 310 is a substrate containing basic circuits, electronic elements and parts for the operation of the portable terminal. The main board 310 provides an operations execution environment of the portable terminal, maintains information thereof, allows the portable terminal to be stably driven, and allows data input/output exchange of all units of the portable terminal to be swiftly performed. The main board includes a Central Processing Unit (CPU), a microprocessor, an auxiliary processor, a memory, a bios, a connection circuit, and other similar operational and electronic elements. The grounding portion 302 of the main board 310 blocks a hazardous factor such as a noise from effecting operations of the portable terminal. In addition, the feeding portion 301 may be fed by being electrically connected to a Radio Frequency (RF) chip for wireless communication.

The bar antenna 320 is protruded to the outside of the portable terminal or inserted into the inside of the portable terminal. In addition, the bar antenna 320 may have a structure that allows the bar antenna 320 to protrude to the outside and increase its length. For example, the bar antenna 320 may freely stretch by being composed of several sequentially overlapping metal pipes having different diameters, respectively, and thus forming an extendable and retractable antenna.

As described above, the antenna device 300, according to an exemplary embodiment of the present invention, allows for the bar antenna 320 to protrude to the outside of the portable terminal so as to operate as an external monopole antenna. Generally, a maximum extension length of the bar antenna 320 may be ½˜¼ of a wavelength λ. In addition, the antenna device 300 allows for the bar antenna 320 to be inserted into the inside of the portable terminal so as to operate as the PIFA antenna. That is, the bar antenna 320 has the PIFA antenna structure and is electrically fed from the main board 310 and grounded to the main board 310. Furthermore, the bar antenna 320 is spaced apart from the main board 310 in a vertical and/or horizontal direction. The antenna device 300 operating as the PIFA antenna forms a circuit transmit line when a current supplied from the main board 310 is transferred to the bar antenna 320 via the feeding portion 301 and the current that has circulated through the bar antenna 320 returns to the grounding portion 302 of the main board 310 via the connector 330. The antenna device 300 operating as the PIFA antenna may transmit and receive radio waves using the circuit transmit line described above.

The feeding portion 301 of the main board 310 feeds electricity to the bar antenna 320. For this purpose, the feeding portion 301 may have an elastic portion such as a pogo pin, a metal elastic bar, and a metal elastic spring at an end portion of the feeding portion 301. The elastic portion of the feeding portion 301 and the bar antenna 320 contact each other using an elastic support. Therefore, the bar antenna 320 may move while contacting the elastic portion. In addition, the feeding portion 301 has a structure that surrounds the bar antenna 320. The bar antenna 320 contact the feeding portion 301 while sliding along or through the feeding portion 301.

The connector 330 is electrically connected with the bar antenna 320 when the bar antenna 320 is completely inserted into the inside of the portable terminal. For example, the connector 330 may have a structure that is electrically connected with the bar antenna 320 when an end of the bar antenna 320 is mechanically bound inside of the potable terminal.

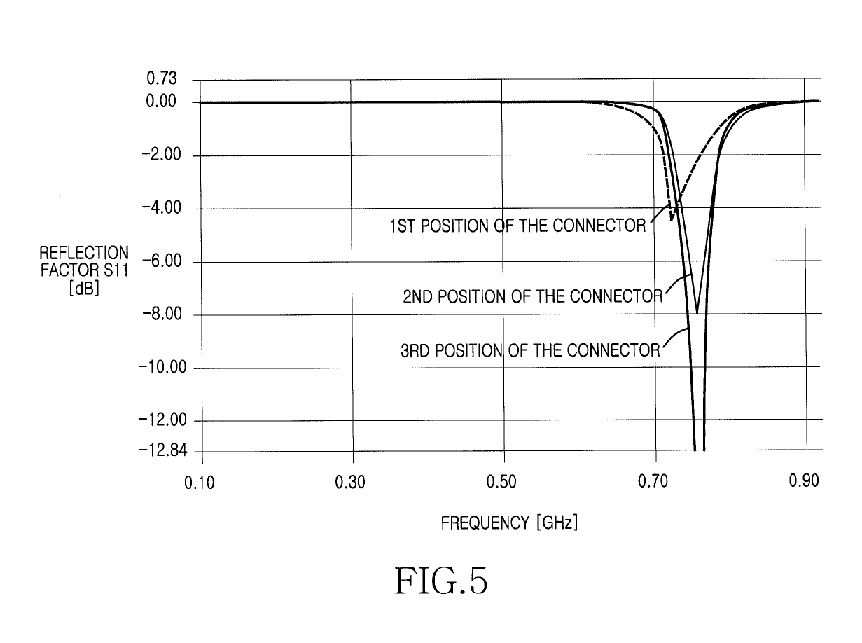

In addition, although not required in all aspects of the present invention, the main board 310 may have a switching unit for electrically connecting the connector 330 with the bar antenna 320 when switched on. For example, the main board 310 may have a structure that allows the end of the bar antenna 320 to switch on the switching unit of the main board 310 when the bar antenna 320 is completely inserted into the portable terminal. Furthermore, depending on the positions of the feeding portion 301 and the connector 330 of the main board 310, the radiation characteristic of the antenna device 300 may change, which will be described with reference to FIG. 5.

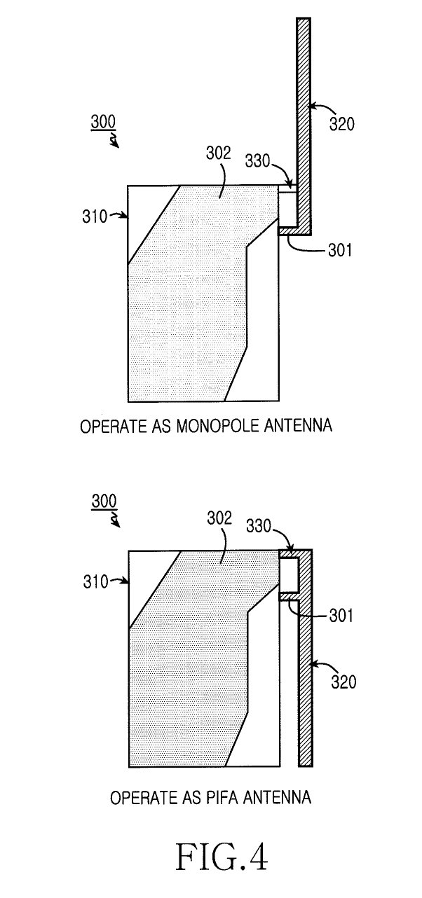

FIG. 4 is a view illustrating an operation of an antenna device of a portable terminal according to an exemplary embodiment of the present invention.

Referring to FIG. 4, the bar antenna 320 is electrically fed from the feeding portion 301 of the main board 310. However, when protruded to the outside of the portable terminal, the bar antenna 320 is only electrically fed from the main board 310 via the feeding portion 301. Therefore, the antenna device 300, when protruded to the outside of the portable terminal, operates as an external monopole antenna. Furthermore, when the bar antenna 320 is inserted into the inside of the portable terminal, the bar antenna 320 is electrically connected with the grounding portion 302 as well as the feeding portion 310 of the main board 310. Therefore, the antenna device 300 according to an exemplary embodiment of the present invention operates as a PIFA antenna when inserted into the inside of the portable terminal.

The external monopole antenna and the PIFA antenna provided by the antenna device according to an exemplary embodiment of the present invention may transmit and receive radio waves in the same frequency band. In addition, the antenna device according to an exemplary embodiment of the present invention may transmit and receive radio waves in a Digital Multimedia Broadcasting (DMB) frequency band.

FIG. 5 is a view illustrating a radiation characteristic when an antenna device of a portable terminal according to an exemplary embodiment of the present invention operates as a PIFA antenna.

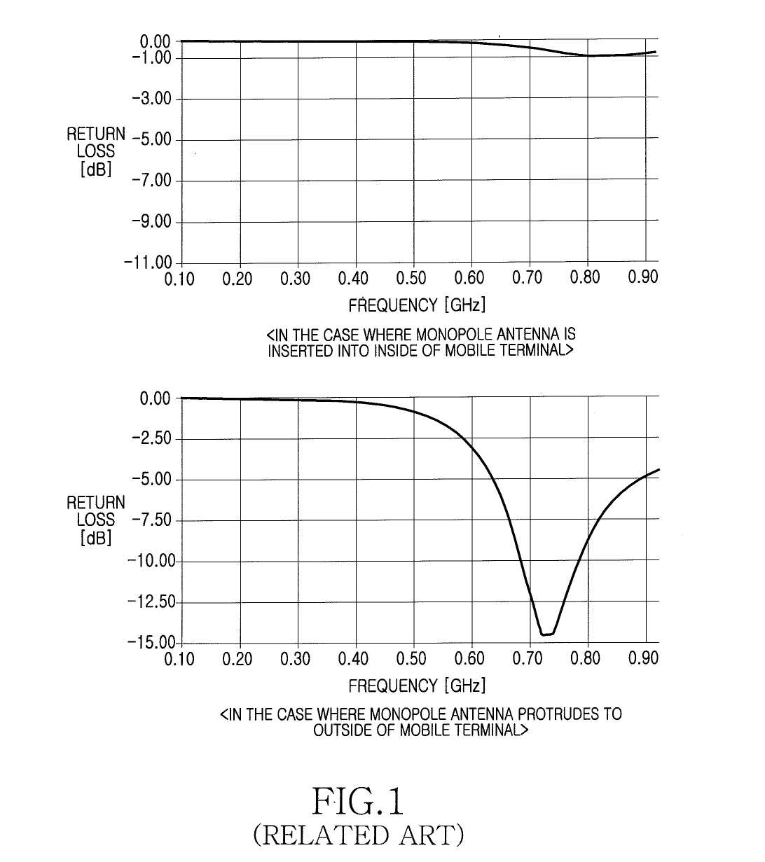

As described with reference to FIG. 1, when a monopole antenna of the related art is inserted into the inside of the portable terminal, the monopole antenna of the related art has a deteriorated radiation performance in a relevant frequency band. In contrast, and with reference to FIG. 5, the antenna device according to an exemplary embodiment of the present invention operates as a PIFA antenna when a bar antenna 320 is inserted into the inside of the portable terminal, such that a radiation performance is secured so as to not deteriorate at the relevant frequency band. Furthermore, depending on a position of the feeding portion 301 or the connector 330 that electrically contacts the bar antenna 320, the radiation characteristic changes. FIG. 5 shows the radiation characteristic depending on three different positions of the connector 330.

Consequently, the antenna device according to an exemplary embodiment of the present invention provides a desired radiation performance even when the bar antenna that transmits and receives radio waves is protruded to the outside of the portable terminal or inserted into the inside of the portable terminal.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. An antenna device of a portable terminal, the device comprising:
a main board comprising a feeding portion for feeding electricity and a grounding portion for grounding;
a bar antenna that is movable while being electrically connected to the feeding portion so as to protrude to an outside of the portable terminal or to be inserted into an inside of the portable terminal; and
a connector for electrically connecting the grounding portion of the main board to the bar antenna when the bar antenna is completely inserted into the portable terminal.

2. The device of claim 1, wherein the bar antenna is spaced apart from the grounding portion of the main board in a vertical or a horizontal direction.

3. The device of claim 1, wherein the connector is electrically connected with an end of the bar antenna when the end of the bar antenna is mechanically bound inside of the portable terminal.

4. The device of claim 1, wherein the feeding portion comprises one of a pogo pin, a metal elastic bar, and a metal elastic spring, and
wherein one of the pogo pin, the metal elastic bar, and the metal elastic spring contacts the bar antenna using an elastic support.

5. The device of claim 1, wherein the bar antenna contacts the feeding portion while sliding along the feeding portion.

6. The device of claim 1, wherein the main board further comprises a switching unit for connecting the connector with the bar antenna when switched on, and
wherein, when the bar antenna is completely inserted into the portable terminal, an end of the bar antenna switches on the switching unit of the main board.

7. The device of claim 1, wherein the device transmits and receives radio waves in a Digital Multimedia Broadcasting (DMB) frequency band.

8. The device of claim 1, wherein the bar antenna is formed of sequentially overlapping several metal pipes having different diameters so as to have an extendable length.

9. An antenna device of a portable terminal having a main board including a feeding portion for feeding electricity and a grounding portion for grounding, the device comprising:
a bar antenna electrically connected to the feeding portion and movable so as to protrude to an outside position of the portable terminal or retract to an inside position of the portable terminal; and
a connector for electrically connecting the grounding portion of the main board to the bar antenna when the bar antenna is retracted into the portable terminal.

10. The device of claim 9, wherein the connector is not connected to the bar antenna when the bar antenna is protruded out of the portable terminal.

11. The device of claim 9, wherein the bar antenna is spaced apart from the grounding portion of the main board in a vertical or a horizontal direction.

12. The device of claim 9, wherein the connector is electrically connected with an end of the bar antenna when the end of the bar antenna is mechanically bound inside of the portable terminal.

13. The device of claim 9, wherein the feeding portion comprises one of a pogo pin, a metal elastic bar, and a metal elastic spring, and
wherein one of the pogo pin, the metal elastic bar, and the metal elastic spring contacts the bar antenna using an elastic support.

14. The device of claim 9, wherein the bar antenna contacts the feeding portion while sliding along the feeding portion.

15. The device of claim 9, wherein the main board further comprises a switching unit for connecting the connector with the bar antenna when switched on, and
wherein, when the bar antenna is completely inserted into the portable terminal, an end of the bar antenna switches on the switching unit of the main board.

16. The device of claim 9, wherein the device transmits and receives radio waves in a Digital Multimedia Broadcasting (DMB) frequency band.

17. The device of claim 9, wherein the bar antenna is formed of sequentially overlapping several metal pipes having different diameters so as to have an extendable length.

18. An antenna device of a portable terminal, the device comprising:
a bar antenna electrically coupled to a feeding portion of a main board and movable to an outside position of the portable terminal or to an inside position of the portable terminal wherein the feeding portion of the main board is for feeding electricity; and
a connector for electrically coupling a grounding portion of the main board to the bar antenna when the bar antenna is retracted into the portable terminal wherein the feeding portion of the main board is for grounding.

19. The device of claim 19, wherein the connector is not connected to the bar antenna when the bar antenna is protruded out of the portable terminal.

20. The device of claim 19, wherein the bar antenna is spaced apart from the grounding portion of the main board in a vertical or a horizontal direction.
